(19) United States
(12) Patent Application Publication
(10) Pub. No.: US 2025/0336406 A1
(43) Pub. Date: Oct. 30, 2025

(54) SYSTEMS AND METHODS FOR ENCODING DATA ASSOCIATED WITH VOICE OBFUSCATION

(71) Applicant: Verizon Patent and Licensing Inc., Basking Ridge, NJ (US)

(72) Inventors: Sudhakar Reddy PATIL, Flower Mound, TX (US); Ravi POTLURI, Coppell, TX (US); Vinod Kumar CHOYI, Conshohocken, PA (US); Yousif TARGALI, Sammamish, WA (US)

(73) Assignee: Verizon Patent and Licensing Inc., Basking Ridge, NJ (US)

(21) Appl. No.: 18/647,410

(22) Filed: Apr. 26, 2024

(51) Int. Cl. G10L 21/007; G10L 15/00; G10L 15/30; H04L 9/40

(52) U.S. Cl. CPC G10L 21/007; G10L 15/005; G10L 15/30; H04L 63/0414; H04L 63/0428

(57) ABSTRACT

In some implementations, a device may detect a voice call involving a user. The device may identify a usage of user-specific language or vocabulary based on a usage pattern. The device may generate, based on the user-specific language or vocabulary, one or more replacement words to replace words spoken by the user during the voice call. The device may generate a random value to be applied to the voice call to create voice obfuscation for the voice call, wherein the random value is used to obfuscate one or more voice characteristics of the voice call. The device may communicate encoded data associated with the voice call, wherein the encoded data is in accordance with the voice obfuscation.

### BACKGROUND

Communication systems are widely deployed to provide various telecommunication services such as telephony, video, data, messaging, and broadcasts. A network may include one or more network nodes that support communication for wireless communication devices.

### BRIEF DESCRIPTION OF THE DRAWINGS

FIG. 1 is a diagram of encoding data associated with voice obfuscation.

FIG. 2 is a diagram of an example environment in which systems and/or methods described herein may be implemented.

FIG. 3 is a diagram of example components of one or more devices of FIG. 2.

FIG. 4 is a flowchart of an example process associated with encoding data associated with voice obfuscation.

### DETAILED DESCRIPTION OF EXAMPLE EMBODIMENTS

The following detailed description of example implementations refers to the accompanying drawings. The same reference numbers in different drawings may identify the same or similar elements.

A callee may be a person that receives a call. The call may be an audio call or a video call. A caller may be a person that makes the call. Voice may be used to identify the caller and/or the callee. For example, the callee may rely on the voice of the caller to identify the caller. In some cases, the caller may be a potential attacker and the callee may be a potential victim. In this case, when the caller is not a person that is recognized by the callee, the callee may opt to disconnect the call, the callee may be apprehensive or doubt an intention of the call, and/or the callee may not completely trust the caller. When the callee receives the call, the callee may like to ensure an authenticity of the caller and/or a trustworthiness/identity of the caller. Alternatively, the callee may be the potential attacker, and the caller may be the potential victim.

Users may engage in a number of communications that include audio (e.g., the user's voice) and/or video on a daily basis.

Spoofing audio and video may become a common event with the advent of machine learning and/or artificial intelligence (AI/ML) solutions, and/or with expanded use of quantum computing for potentially decrypting encrypted audio and video calls. For example, with AI and generative AI, an attacker may use snippets of audio (e.g., voice) from the callee and/or the caller to impersonate trusted people. Audio and/or video samples may be harvested from previous conversations (e.g., audio of the trusted person from a previous conversation may be stored and used by the attacker at a later time), audio available on the Internet, and/or from other sources. The attacker may use the impersonation of a trusted person to launch an attack, thereby putting the callee at risk. In this case, the callee may believe that the trusted person is communicating on the call, instead of the attacker, and the callee may unknowingly provide sensitive information to the attacker. In certain situations, the callee may be the potential attacker, and the caller may be the potential victim.

In addition, the attacker may obtain one or both of audio/video samples of a vocabulary and/or certain usages that are typical of the callee (e.g., an accent associated with the callee, or common words used by the callee), and a generative AI/ML model may be trained with one or both of the audio/video samples of the vocabulary and/or certain usages. The attacker may use the generative AI/ML model to provide spoofed audio of the callee's voice to impersonate the caller or callee to attack others who trust the caller or callee. A user, such as the callee, may want to ensure that their voice is protected and not used by the attacker.

In some implementations, a user during a call, such as a callee, may identify whether a caller that initiated the call is known to the callee, and depending on whether the caller is known or unknown, the callee may opt to change a pitch, tone, and/or note of the callee's voice at a voice controller in a user equipment (UE). In this scenario, the callee may be a potential victim, and the caller may be a potential attacker. The changing of the pitch, tone, and/or note of the callee's voice may be referred to as a voice obfuscation. The callee may indicate, via a user interface of the UE, that voice obfuscation should be employed. Alternatively, or additionally, the UE may leverage an AI/ML model to determine whether voice obfuscation is to be used. For example, the AI/ML model may look at various factors, such as whether the caller is on a contact list, a time of day, a phone number associated with the caller, a location associated with the caller, etc., and determine whether to recommend voice obfuscation. The AI/ML model may run locally on the UE, or the AI/ML model may run on a network device. Alternatively, or additionally, the UE and/or the network device may leverage a spam detection engine. The UE, using the spam detection engine running on the UE, or in conjunction with network assistance, may detect spam calls. For example, a spam call may be detected when the caller is not on the contact list.

In some implementations, the UE and/or the network device may generate one or more random values, which may be mixed with the pitch, tone, and/or note of the callee's voice in order to create obfuscation of the callee's voice. The UE and/or the network device may employ an AI/ML model to detect a vocabulary of the callee based on words spoken by the callee, and then the UE and/or the network device may use generative AI to provide obfuscation of the callee's vocabulary. For example, during the voice obfuscation, the UE and/or the network device may replace the callee's spoken words with AI generated words.

In some implementations, by obfuscating the user's voice during the call, the user's voice may not be maliciously stored and then later used to impersonate the user when the user is a callee or a caller in a future call. The voice and/or video of the user may be protected as an identity. Obfuscating the user's voice may reduce a likelihood of spoofed audio or video involving the user's identity. The user may be less likely to be subjected to attacks because the user's voice may be protected to not be used by the attacker. Such attacks may include identity theft or malware loaded onto the UE, which may degrade an overall performance of the UE.

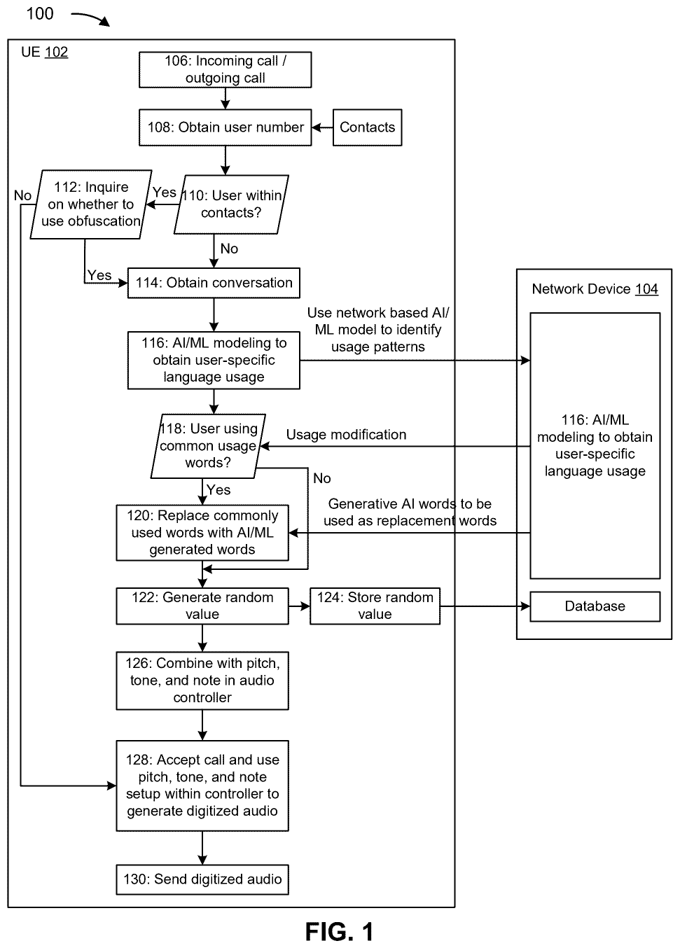

FIG. 1 is a diagram of an example 100 associated with encoding data associated with voice obfuscation. As shown in FIG. 1, example 100 includes a UE 102 and a network device 104. The UE 102 may be a first UE, and the first UE may be involved in a voice call with a second UE (not shown in FIG. 1). The voice call may involve a callee and a caller. The callee may be a person that is receiving the voice call. The caller may be a person that is making the voice call. A user may refer to either the callee or the caller. The user associated with the UE 102 may be either the callee or the caller.

As shown by reference number 106, the UE 102 may detect an incoming call or an outgoing call (e.g., with the second UE). The incoming call or the outgoing call may be the voice call. The voice call may or may not include video. As shown by reference number 108, the UE 102 may obtain a user number associated with the voice call or an identifier from the voice call. For example, the user number may be a caller number or identifier.

As shown by reference number 110, the UE 102 may determine, using a contact list associated with the UE 102, whether the user is within the contact list. For example, the UE 102 may compare the user number with the contact list, and then determine whether or not the user number is on the contact list. The UE 102 may run a spam detection engine. The spam detection engine may be used to determine whether or not the user number is on the contact list. In some cases, the spam detection engine, in conjunction with network assistance, may determine whether the voice call is a spam call.

As shown by reference number 112, when the user number is on the contact list, or when the voice call is determined to not be spam, the UE 102 may display a notification, which may inquire the user associated with the UE 102 on whether to use anonymization or voice obfuscation. In other words, the user may have an option for anonymization or voice obfuscation, or the user may have an option to skip anonymization or voice obfuscation when the caller is within the contact list or is not flagged as a spam or when the caller has been deemed to be trustworthy based on a device or network AI system.

As shown by reference number 114, when the user selects to use anonymization or voice obfuscation, when the user number is not on the contact list, or when the voice call is determined to be spam, the UE 102 may obtain a voice conversation associated with the callee before sending the voice conversation to the caller. The voice conversation may be between the callee and the caller. The UE 102 may obtain an audio file that includes the voice conversation that is associated with the callee.

As shown by reference number 116, the UE 102 and/or the network device 104 may use AI/ML modeling to obtain user-specific language usage associated with the callee. The UE 102 and/or the network device 104 may identify a usage of user-specific language or vocabulary based on a usage pattern. The UE 102 and/or the network device 104 may determine whether the voice conversation contains the usage of language or vocabulary that is unique to the callee/user. The UE 102 may utilize the network device 104 for network-based AI/ML modeling to identify usage patterns. The UE 102 and/or the network device 104 may identify specific words spoken by the user, a type of accent associated with the user, and/or unique vocabulary used by the user, based on the AI/ML modeling. The UE 102 and/or the network device 104 may take a voice snippet from the voice conversation and perform a processing on the voice snippet to obtain information that characterizes the voice snippet. The information may be fed into an AI/ML model, either on the UE 102 or on the network device 104, and an output of the AI/ML model may indicate the user-specific language usage. A determination of user unique vocabulary or language may be determined by AI models present on the UE 102 or with assistance of the network device 104.

As shown by reference number 118, the UE 102 and/or the network device 104 may determine whether the user is using common usage words, which may be based on the user-specific language usage. For example, the network device 104 may indicate which part of the usage is to be modified (e.g., which common words of the user are to be modified), or the network device 104 may assist the UE 102 with identifying the common usage words that are associated with the user-specific language usage. The common usage words may be specific to the user, and may not necessarily be applicable to other users.

As shown by reference number 120, the UE 102 may replace the commonly used words with replacement words, which may be AI/ML generated words or generative AI words. The UE 102 may receive the replacement words from the network device 104. Alternatively, the UE 102 may run an AI/ML model that produces the replacement words. For example, in the audio file that includes the chunk of the voice conversation, the UE 102 may replace some words (e.g., the commonly used words) with the replacement words, where the replacement words may not be actually spoken by the user. The replacement words may be generated by generative AI mechanisms present on the UE 102 or with assistance of the network device 104.

As shown by reference number 122, the UE 102 may generate a random value. For example, the random value may be a value of 256 bits or more. As shown by reference number 124, the UE 102 may store the random value locally, and/or transmit the random value for storage in a database of the network device 104. The UE 102 may generate the random value, or alternatively, the network device 104 may generate the random value and provide the random value to the UE 102. The random value may be generated by the UE 102 and stored locally, or generated with assistance by the network device 104.

In some implementations, the random value may be used to determine a non-repudiability of the user or callee. For example, the random value may be used to provide proof of origin, authenticity, and/or integrity of audio data associated with the callee, where the audio data may be from the audio file of the voice conversation. The random value, when used to provide non-repudiation, may provide an assurance that the voice conversation is indeed from the callee (e.g., the callee cannot deny that certain words were spoken by them when non-repudiation is provided).

As shown by reference number 126, the UE 102, via an audio controller, may apply or combine (e.g., with an XOR operation) the random value with a pitch, tone, and/or note associated with the user, which may result in a voice obfuscation of the voice call. The UE 102 may use the random value to obfuscate one or more voice characteristics of the voice conversation, where the one or more voice characteristics may refer to the pitch, tone, and/or note of the user. The voice obfuscation may be associated with a change in pitch, a change in tone, and/or a change in note of the voice of the user. The UE 102 may apply the random value to replaced words and/or non-replaced words in the audio file of the voice conversation. In some cases, the voice obfuscation may be in response to the user in the voice call not being included on the contact list. For example, the voice obfuscation may be in response to the caller in the voice call not being included in the contact list of the callee in the voice call.

As shown by reference number 128, the UE 102 may accept the voice call and use the pitch, tone, and/or note setup within the audio controller to generate encoded data (e.g., digitized audio), which may occur after the random value is combined with the pitch, tone, and/or note associated with the user. When the user does not select to use anonymization or voice obfuscation, the UE 102 may accept the voice call and use the pitch, tone, and/or note setup within the audio controller to generate the encoded data. The stored random value may be used at a later point in time to determine an actual voice of the caller, by performing the reverse decoding process (e.g., XOR on an obfuscated/encoded voice).

As shown by reference number 130, the UE 102 may transmit the encoded data. For example, the UE 102 may transmit the encoded data to the second UE when the voice conversation involves the UE 102 and the second UE. The encoded data may be associated with voice obfuscation. For example, the encoded data may include words spoken by the user, where the pitch, tone, and/or note of the words may be altered using AI, such that the voice in the encoded data is not an actual voice of the user. As a result, the voice of the user may be less likely to be stored and later used to launch an attack.

As indicated above, FIG. 1 is provided as an example. Other examples may differ from what is described with regard to FIG. 1. The number and arrangement of devices shown in FIG. 1 are provided as an example. In practice, there may be additional devices, fewer devices, different devices, or differently arranged devices than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) shown in FIG. 1 may perform one or more functions described as being performed by another set of devices shown in FIG. 1.

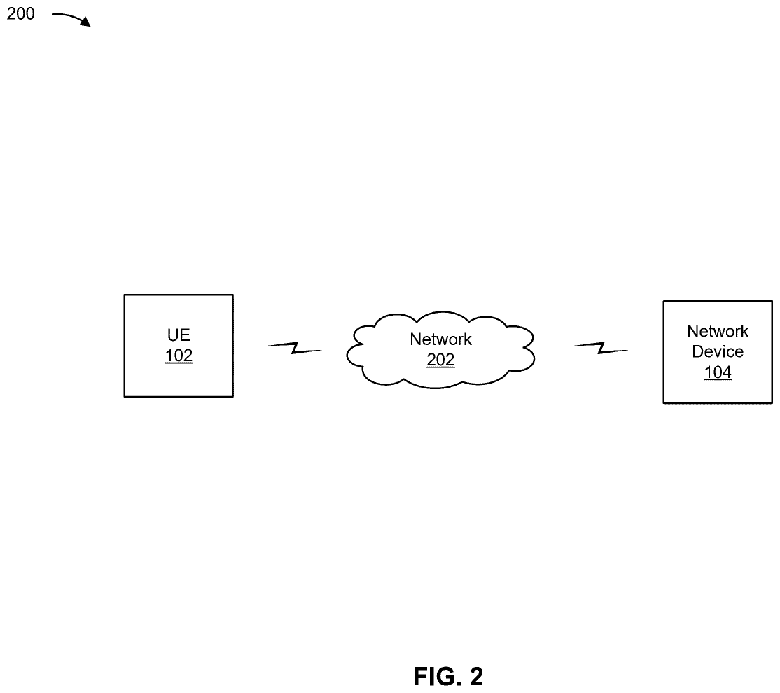

FIG. 2 is a diagram of an example environment 200 in which systems and/or methods described herein may be implemented. As shown in FIG. 2, environment 200 may include a UE 102, a network device 104, and a network 202. Devices of environment 200 may interconnect via wired connections, wireless connections, or a combination of wired and wireless connections.

The UE 102 may include one or more devices capable of receiving, generating, storing, processing, and/or providing information associated with encoding data associated with voice obfuscation, as described elsewhere herein. The UE 102 may include a communication device and/or a computing device. For example, the UE 102 may include a wireless communication device, a mobile phone, a laptop computer, a tablet computer, a desktop computer, a gaming console, a set-top box, a wearable communication device (e.g., a smart wristwatch, a pair of smart eyeglasses, a head mounted display, or a virtual reality headset), a smart television, an IoT device, or a similar type of device.

The network device 104 may include one or more devices capable of receiving, processing, storing, routing, and/or providing information associated with encoding data associated with voice obfuscation, as described elsewhere herein. The network device 104 may be an aggregated network node, meaning that the aggregated network node is configured to utilize a radio protocol stack that is physically or logically integrated within a single radio access network (RAN) node (e.g., within a single device or unit). The network device 104 may be a disaggregated network node (sometimes referred to as a disaggregated base station), meaning that the network device 104 is configured to utilize a protocol stack that is physically or logically distributed among two or more nodes (such as one or more central units (CUs), one or more distributed units (DUs), or one or more radio units (RUs)). The network device 104 may include, for example, a New Radio (NR) base station, a long-term evolution (LTE) base station, a Node B, an eNB (e.g., in 4G), a gNB (e.g., in 4G), an access point, a transmission reception point (TRP), a DU, an RU, a CU, a mobility element of a network, a core network node, a network element, a network equipment, and/or a RAN node.

The network 202 may include one or more wired and/or wireless networks. For example, the network 202 may include a cellular network (e.g., a 5G network, a 4G network, a LTE network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, and/or a combination of these or other types of networks. The network 202 enables communication among the devices of environment 300.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

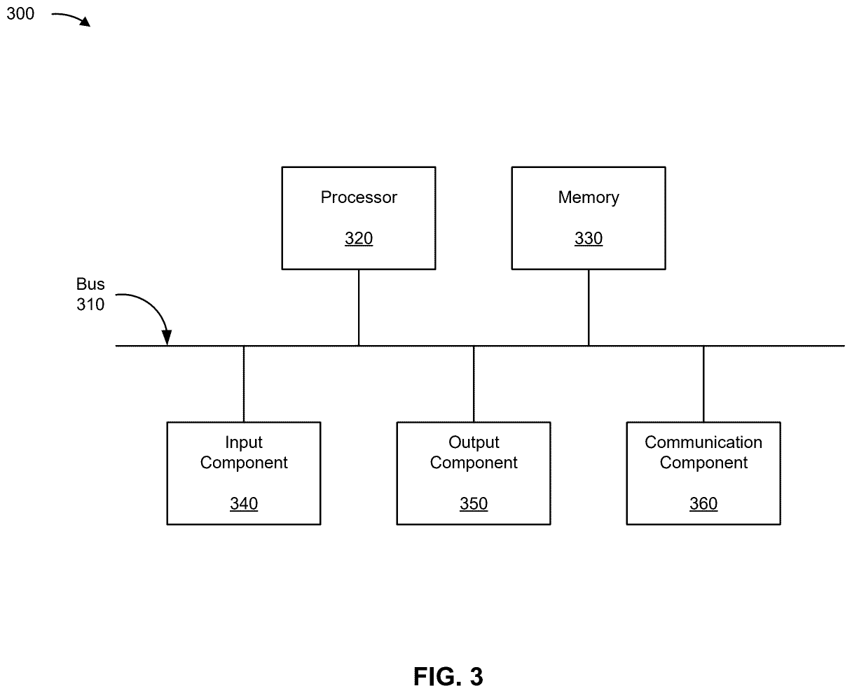

FIG. 3 is a diagram of example components of a device 300 associated with encoding data associated with voice obfuscation. The device 300 may correspond to a device, such as a UE (e.g., UE 102) or a network device (e.g., network device 104). In some implementations, the device may include one or more devices 300 and/or one or more components of the device 300. As shown in FIG. 3, the device 300 may include a bus 310, a processor 320, a memory 330, an input component 340, an output component 350, and/or a communication component 360.

The bus 310 may include one or more components that enable wired and/or wireless communication among the components of the device 300. The bus 310 may couple together two or more components of FIG. 3, such as via operative coupling, communicative coupling, electronic coupling, and/or electric coupling. For example, the bus 310 may include an electrical connection (e.g., a wire, a trace, and/or a lead) and/or a wireless bus. The processor 320 may include a central processing unit, a graphics processing unit, a microprocessor, a controller, a microcontroller, a digital signal processor, a field-programmable gate array, an application-specific integrated circuit, and/or another type of processing component. The processor 320 may be implemented in hardware, firmware, or a combination of hardware and software. In some implementations, the processor 320 may include one or more processors capable of being programmed to perform one or more operations or processes described elsewhere herein.

The memory 330 may include volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. The memory 330 may store information, one or more instructions, and/or software (e.g., one or more software applications) related to the operation of the device 300. In some implementations, the memory 330 may include one or more memories that are coupled (e.g., communicatively coupled) to one or more processors (e.g., processor 320), such as via the bus 310. Communicative coupling between a processor 320 and a memory 330 may enable the processor 320 to read and/or process information stored in the memory 330 and/or to store information in the memory 330.

The input component 340 may enable the device 300 to receive input, such as user input and/or sensed input. For example, the input component 340 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 350 may enable the device 300 to provide output, such as via a display, a speaker, and/or a light-emitting diode. The communication component 360 may enable the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

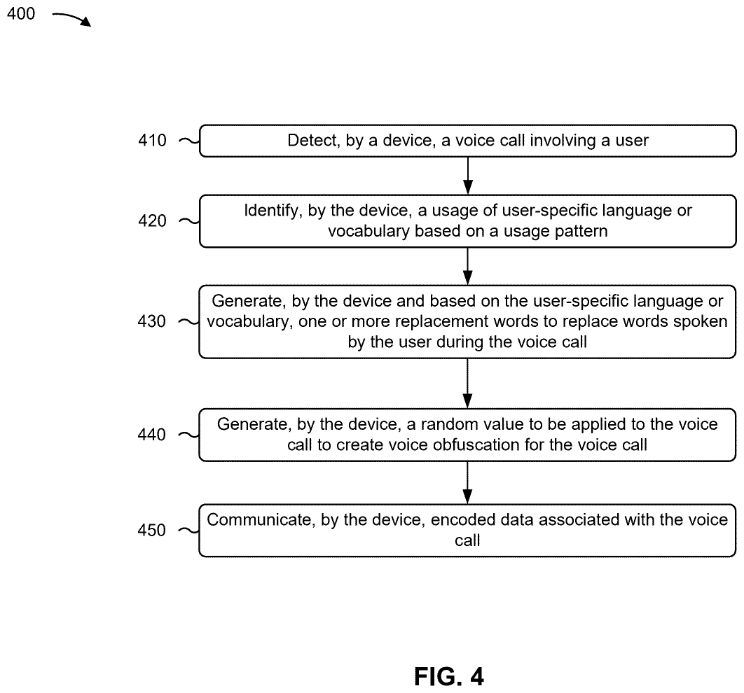

FIG. 4 is a flowchart of an example process 400 associated with encoding data associated with voice obfuscation. In some implementations, one or more process blocks of FIG. 4 may be performed by a device, such as a UE (e.g., UE 102) or a network device (e.g., network device 104). In some implementations, one or more process blocks of FIG. 4 may be performed by another device or a group of devices separate from or including the device. Additionally, or alternatively, one or more process blocks of FIG. 4 may be performed by one or more components of device 300, such as processor 320, memory 330, input component 340, output component 350, and/or communication component 360.

As shown in FIG. 4, process 400 may include detecting, by the device, a voice call involving a user (block 410). The user may be a callee of the voice call, or the user may be a caller of the voice call. The voice call may be between two UEs.

As shown in FIG. 4, process 400 may include identifying, by the device, a usage of user-specific language or vocabulary based on a usage pattern (block 420). The device may identify the usage of user-specific language based on an AI/ML model running on the device.

As shown in FIG. 4, process 400 may include generating, by the device and based on the user-specific language or vocabulary, one or more replacement words to replace words spoken by the user during the voice call (block 430). The device may generate the one or more replacement words based on an AI/ML model running on the device.

As shown in FIG. 4, process 400 may include generating, by the device, a random value to be applied to the voice call to create voice obfuscation for the voice call, wherein the random value is used to obfuscate one or more voice characteristics of the voice call (block 440). The voice characteristics may be associated with one or more of: a pitch, a tone, or a note associated with a voice of the user. The voice obfuscation may be associated with one or more of: a change in pitch, a change in tone, or a change in note of the voice of the user. The device may apply the random value to one or more of replaced words or non-replaced words. The device may store the random value in a local memory, or alternatively, the device may transmit the random value for storage in an external memory. The random value may be useable for non-repudiation of the user.

As shown in FIG. 4, process 400 may include communicating, by the device, encoded data associated with the voice call, wherein the encoded data is in accordance with the voice obfuscation (block 450). The voice obfuscation may be in response to the caller of the voice call not being included in a contact list of the callee of the voice call. The encoded data, with the voice obfuscation, may prevent the user's actual voice from being misused in an attack.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is Intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
detecting, by a device, a voice call involving a user;
identifying, by the device, a usage of user-specific language or vocabulary based on a usage pattern;
generating, by the device and based on the user-specific language or vocabulary, one or more replacement words to replace words spoken by the user during the voice call;
generating, by the device, a random value to be applied to the voice call to create voice obfuscation for the voice call, wherein the random value is used to obfuscate one or more voice characteristics of the voice call; and
communicating, by the device, encoded data associated with the voice call, wherein the encoded data is in accordance with the voice obfuscation.

2. The method of claim 1, wherein the voice characteristics is associated with one or more of: a pitch, a tone, or a note associated with a voice of the user, and the voice obfuscation is associated with one or more of: a change in pitch, a change in tone, or a change in note of the voice of the user.

3. The method of claim 1, further comprising:
applying the random value to one or more of replaced words or non-replaced words.

4. The method of claim 1, wherein identifying the usage of user-specific language is based on an artificial intelligence or machine learning (AI/ML) model running on the device.

5. The method of claim 1, wherein generating the one or more replacement words is based on an artificial intelligence or machine learning (AI/ML) model running on the device.

6. The method of claim 1, further comprising:
storing, by the device, the random value in a local memory; or
transmitting, by the device, the random value for storage in an external memory, wherein the random value is useable for non-repudiation of the user.

7. The method of claim 1, wherein the voice obfuscation is in response to a caller in the voice call not being included in a contact list of a callee in the voice call.

8. The method of claim 1, wherein the user is a callee of the voice call or the user is a caller of the voice call.

9. The method of claim 1, wherein the device is a network device or a user equipment (UE).

10. A device, comprising:
one or more processors configured to:
detect a voice call involving a user;
identify a usage of user-specific language or vocabulary based on a usage pattern;
generate, based on the user-specific language or vocabulary, one or more replacement words to replace words spoken by the user during the voice call;
generate a random value to be applied to the voice call to create voice obfuscation for the voice call, wherein the random value is used to obfuscate one or more voice characteristics of the voice call; and
communicate encoded data associated with the voice call, wherein the encoded data is in accordance with the voice obfuscation.

11. The device of claim 10, wherein the voice characteristics is associated with one or more of: a pitch, a tone, or a note associated with a voice of the user, and the voice obfuscation is associated with one or more of: a change in pitch, a change in tone, or a change in note of the voice of the user.

12. The device of claim 10, wherein the one or more processors are further configured to:
apply the random value to one or more of replaced words or non-replaced words.

13. The device of claim 10, wherein the one or more processors are configured to identify the usage of user-specific language or vocabulary based on an artificial intelligence or machine learning (AI/ML) model running on the device.

14. The device of claim 10, wherein the one or more processors are configured to generate one or more replacement words based on an artificial intelligence or machine learning (AI/ML) model running on the device.

15. The device of claim 10, wherein the one or more processors are further configured to:
store the random value in a local memory; or
transmit the random value for storage in an external memory, wherein the random value is useable for non-repudiation of the user.

16. The device of claim 10, wherein the device is a network device or a user equipment (UE).

17. A non-transitory computer-readable medium storing a set of instructions, the set of instructions comprising:
one or more instructions that, when executed by one or more processors of a device, cause the device to:
detect a voice call involving a user;
identify a usage of user-specific language or vocabulary based on a usage pattern;
generate, based on the user-specific language or vocabulary, one or more replacement words to replace words spoken by the user during the voice call;
generate a random value to be applied to the voice call to create voice obfuscation for the voice call, wherein the random value is used to obfuscate one or more voice characteristics of the voice call; and
communicate encoded data associated with the voice call, wherein the encoded data is in accordance with the voice obfuscation.

18. The non-transitory computer-readable medium of claim 17, wherein the one or more instructions, when executed by the one or more processors, further cause the device to:
apply the random value to one or more of replaced words or non-replaced words;
store the random value in a local memory; or
transmit the random value for storage in an external memory, wherein the random value is useable for non-repudiation of the user.

19. The non-transitory computer-readable medium of claim 17, wherein the one or more instructions, when executed by the one or more processors, further cause the device to:
identify the usage of user-specific language or vocabulary based on an artificial intelligence or machine learning (AI/ML) model running on the device; and
generate one or more replacement words based on an artificial intelligence or machine learning (AI/ML) model running on the device.

20. The non-transitory computer-readable medium of claim 17, wherein the device is a network device or a user equipment (UE).
